(19) United States
(12) Patent Application Publication
(10) Pub. No.: US 2026/0267567 A1
(43) Pub. Date: Sep. 10, 2026

(54) CLOUD PRINTING SYSTEM AND PRINTER MANAGEMENT METHOD

(71) Applicant: CANON KABUSHIKI KAISHA, Tokyo (JP)

(72) Inventor: Toshiaki Igarashi, Kanagawa (JP)

(21) Appl. No.: 19/557,479

(22) Filed: Mar. 5, 2026

(30) Foreign Application Priority Data
Mar. 10, 2025 (JP) 2025-037709

(51) Int. Cl. G06F 3/12

(52) U.S. Cl. CPC G06F 3/1203; G06F 3/1229; G06F 3/1287

(57) ABSTRACT

A first cloud printing system is provided, in which a printer registered in the first cloud printing system can be registered in a second cloud printing system, and in which a service of providing an input print job to the registered printer is performed. The first cloud printing system holds registration information including information indicating that the registered printer was registered from the first cloud printing system to the second cloud printing system, receives a request, and in a case where the received request is a request involving deletion of the registered printer, transmits to the second cloud printing system a request to delete a printer registered in the second cloud printing system, based on the registration information, and deletes, from the registration information, registration information relating to the registered printer.

### BACKGROUND

### Field of the Technology

The technology of the present disclosure relates to a cloud printing system using a cloud printing service, for example, and a printer management method.

### Description of the Related Art

Cloud printing services in which a print job is submitted via a cloud and transmitted to an image forming apparatus have recently started to become more common. In such a printing system, first, an administrator registers an image forming apparatus with a tenant (user group unit) of a cloud printing service to which the administrator belongs. The administrator sets which user belonging to the tenant is permitted to use the image forming apparatus.

A user with permission to use the image forming apparatus submits a print job to the cloud printing service from a client terminal. The cloud printing service stores received print jobs in a storage. The image forming apparatus obtains print jobs stored in the cloud printing service and prints them. The method of obtaining print jobs may be pull printing or push printing with respect to the cloud printing service. Representative examples of a cloud printing service include Microsoft (registered trademark) Universal Print, uniFLOW Online, and the like.

In Japanese Patent Laid-Open No. 2021-164025, an aspect in which a cloud printing service executes registration processing for an external cloud printing service instead of an image forming apparatus is described. In this case, the cloud printing service obtains the print job stored in the external cloud printing service and hands it over to an image forming apparatus registered in the cloud printing service. The image forming apparatus receives and prints the print job. In this manner, the cloud printing service can cooperate with the external cloud printing service.

In a typical cloud printing service, status changes that occur include service stoppage/deactivation/initialization, tenant deletion/merge, and the like. In the case of such status changes, the cloud printing service performs deletion of registration information of printers registered with it. However, since deletion of printer registration information in a cooperating external cloud printing service is not performed in conjunction with a status change, the printer registration information remains in the external cloud printing service.

### SUMMARY

The technology of the present disclosure appropriately deleting printer registration information in a cooperating external cloud printing service in a case where a status change occurs in a cloud printing service.

According to an aspect of the present disclosure, provided is a first cloud printing system in which a registered printer registered in the first cloud printing system can be registered in a second cloud printing system, and in which a service of providing an input print job to the registered printer is performed, the first cloud printing system comprising: at least one memory storing instructions; and at least one processor that is in communication with the at least one memory and that, when executing the instructions, cooperates with the at least one memory to execute processing, the processing including holding registration information including information indicating the registered printer and information indicating that the registered printer was registered from the first cloud printing system to the second cloud printing system; receiving a request; and in a case where the received request is a request involving deletion of the registered printer, transmitting to the second cloud printing system a request to delete a printer registered in the second cloud printing system from among one or more deletion target printers, based on the registration information, and deleting, from the registration information, registration information relating to the registered printer.

According to the configurations described above, in a case where a status change occurs in a cloud printing service and in particular when the status change leads to printer registration deletion, printer registration information in a cooperating external cloud printing service can be appropriately deleted.

Features of the present disclosure will become apparent from the following description of embodiments with reference to the attached drawings. The following description of embodiments is described by way of example.

### BRIEF DESCRIPTION OF THE DRAWINGS

FIG. 1 is a system configuration diagram of a first embodiment.

FIG. 2A is a diagram illustrating a hardware configuration of a cloud printing service.

FIG. 2B is a diagram illustrating a software configuration of the cloud printing service.

FIG. 3A is a diagram illustrating a registration sequence between an image forming apparatus and the cloud printing service.

FIG. 3B is a diagram illustrating a registration sequence between the image forming apparatus and an external cloud printing service.

FIG. 3C is a diagram illustrating a registration deletion sequence between the image forming apparatus and the external cloud printing service.

FIG. 4A is a diagram illustrating transitions of web screens of the cloud printing service of the first embodiment.

FIG. 4B is a diagram illustrating examples of web screens of the cloud printing service of the first embodiment.

FIG. 4C is a diagram illustrating examples of web screens of the cloud printing service of the first embodiment.

FIG. 4D is a diagram illustrating examples of web screens of the cloud printing service of the first embodiment.

FIG. 4E is a diagram illustrating examples of web screens of the cloud printing service of the first embodiment.

FIG. 4F is a diagram illustrating examples of web screens of the cloud printing service of the first embodiment.

FIG. 4G is a diagram illustrating examples of web screens of the cloud printing service of the first embodiment.

FIG. 4H is a diagram illustrating examples of web screens of the cloud printing service of the first embodiment.

FIG. 4I is a diagram illustrating examples of web screens of the cloud printing service of the first embodiment.

FIG. 4J is a diagram illustrating examples of web screens of the cloud printing service of the first embodiment.

FIG. 4K is a diagram illustrating examples of web screens of the cloud printing service of the first embodiment.

FIG. 4L is a diagram illustrating examples of web screens of the cloud printing service of the first embodiment.

FIG. 4M is a diagram illustrating examples of web screens of the cloud printing service of the first embodiment.

FIG. 4N is a diagram illustrating examples of web screens of the cloud printing service of the first embodiment.

FIG. 4O is a diagram illustrating examples of web screens of the cloud printing service of the first embodiment.

FIG. 4P is a diagram illustrating examples of web screens of the cloud printing service of the first embodiment.

FIG. 4Q is a diagram illustrating examples of web screens of the cloud printing service of the first embodiment.

FIG. 4R is a diagram illustrating examples of web screens of the cloud printing service of the first embodiment.

FIG. 5A is a diagram illustrating an example of registration information of the cloud printing service of the first embodiment.

FIG. 5B is a diagram illustrating an example of a table configuration of the cloud printing service of the first embodiment.

FIG. 5C is a diagram illustrating an example of user information of the cloud printing service of the first embodiment.

FIG. 5D is a diagram illustrating an example of tenant information of the cloud printing service of the first embodiment.

FIG. 6A is a diagram illustrating a web screen including stop service and initialize service states of the cloud printing service of the first embodiment.

FIG. 6B is a diagram illustrating a web screen including delete tenant and merge tenant of the cloud printing service of the first embodiment.

FIG. 7 is a flowchart for when stopping and initializing the cloud printing service of the first embodiment.

FIG. 8 is a flowchart for when deleting a tenant in the cloud printing service of the first embodiment.

FIG. 9 is a flowchart for when merging tenants in the cloud printing service of the first embodiment.

FIG. 10A is a diagram illustrating an example of printer registration information of an external cloud printing service of a second embodiment.

FIG. 10B is a diagram illustrating an example of printer sharing settings information of the external cloud printing service of the second embodiment.

FIG. 11 is a diagram illustrating a printer sharing settings screen of the second embodiment.

FIG. 12 is a diagram illustrating a sequence of registration processing between an image forming apparatus and a cloud printing service of the second embodiment.

FIG. 13 is a flowchart illustrating the sharing processing of the second embodiment in detail.

### DESCRIPTION OF THE EMBODIMENTS

### First Embodiment

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Network Configuration

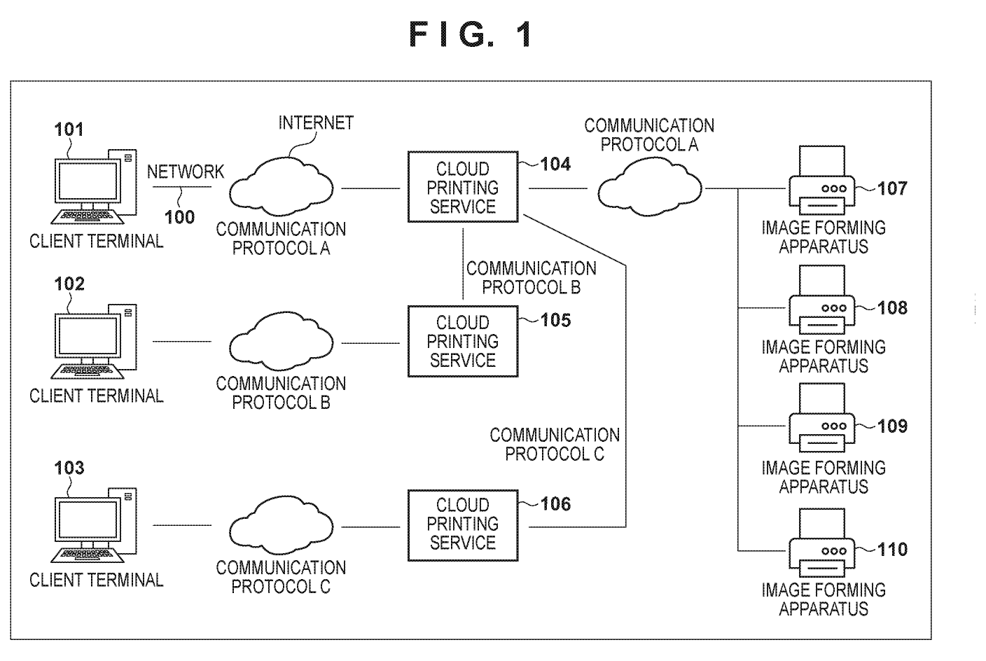

FIG. 1 is a block diagram illustrating a system configuration of a cloud cooperation system according to the present embodiment. Client terminals 101 to 103 submit print jobs to each cloud printing service (CPS). A CPS 104 receives a print job from the client terminal 101 and obtains print jobs from external CPSs 105 and 106. The CPSs105 and 106 are external CPSs that receive and store print jobs from the client terminals 102 and 103. In this example, the CPS 104 has the URL of “cps104.com”, the CPS 105 has the URL of “cps105.com”, and the CPS 106 has the URL of “cps106.com”. Each CPS holds tenants internally. In a case where a tenant name is “Tenant 1”, the URL representing tenant 1 of the CPS 104 corresponds to “tenant1.cps104.com”, with tenant 1 being converted into tenant1. Typically, data belonging to a certain tenant cannot be referenced from another tenant. Image forming apparatuses 107 to 110 are image forming apparatuses (hereinafter, also referred to as printers) that obtain print jobs from the CPS 104 and execute printing processing.

Here, the CPSs104 to 106 are described as services operating on different servers, but they may operate as independent services in a single server. Also, with the CPSs104 to 106, a server failure or the like may cause a service stoppage or initialization.

Each component element described above is connected in a communication-enabling manner via a network 100. The network 100 may be any one of a LAN, a WAN, such as the Internet, a telephone line, a dedicated digital line, an ATM, or the like. Also, the communication network may be implemented via a combination of these. It is sufficient that the network 100 allows for the transmitting and receiving of data.

Here, the CPS 104 cooperates with the CPS 105 and the CPS 106. In other words, a registered printer of the CPS 104 is registered in the CPS 105 and the CPS 106. A registered printer of the CPS 104 does not need to be a printer per se and, in other words, may be a virtual printer provided by the CPS 104 registered in the CPSs105 and 106. Accordingly, a print job submitted to and held by the CPS 105 and the CPS 106 can be, via the CPS 104, printed by a registered printer of the CPS 104.

In each CPS, in response to a request, maintenance such as the addition and deletion of image forming apparatuses and the addition, deletion, and merge of tenants can be performed. Image forming apparatuses that can be the target of maintenance include virtual printers registered in the cooperating CPSs. A tenant maintenance task may be performed by an administrator from an administration terminal of each CPS, for example, and a maintenance task such as the additional registration or deletion of an image forming apparatus can also be performed from an image forming apparatus in addition to an administration terminal.

Note that the cloud printing service is a service provided by a cloud printing server or a cloud printing system, but in the present specification, this is referred to as service meaning the same for server and system. Thus, the term “cloud printing service” may be substituted with cloud printing server or cloud printing system.

### Hardware Configuration

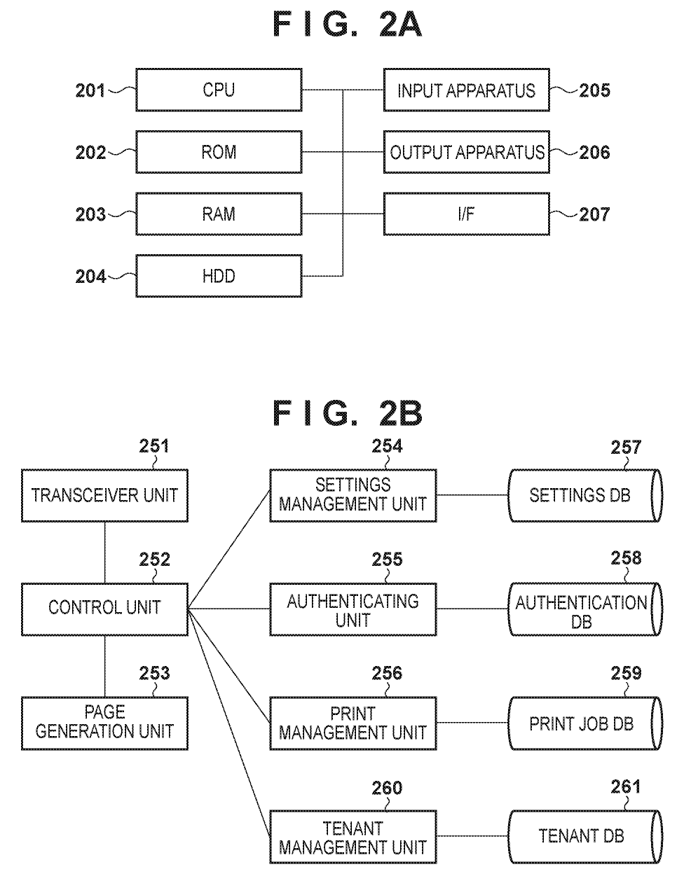

FIG. 2A is a block diagram illustrating the hardware configuration of the CPS 104 of FIG. 1. In the present diagram, a CPU 201 directly or indirectly controls each device (ROM, RAM, and the like) connected by an internal device and executes a program for implementing control according to the present embodiment. A ROM 202 stores a BIOS and the like. A RAM (direct storage apparatus) 203 is used as a work area of the CPU 201, as a primary storage for loading a software module for implementing control according to the present embodiment, and the like. An indirect storage apparatus 204 is a hard disk drive (HDD), a solid state drive (SSD), or the like storing an OS as basic software, software modules, and the like. An input apparatus 205 is a keyboard, a pointing device, or the like. As an output apparatus 206, a display is used, for example. An I/F 207 is an interface for connecting to the network 100.

Note that the client terminals 101 to 103 may have a hardware configuration similar to that of the CPS. Also, the image forming apparatuses 107 to 110 include a printing mechanism and a control mechanism therefor in addition to the hardware illustrated in FIG. 2A. Also, as the hardware configuration, and in particular for the image forming apparatus hardware, a touch panel or the like including the input apparatus 205 and the output apparatus 206 integrally formed may be used.

### Software Configuration

FIG. 2B is a configuration diagram of a software module on the CPS 104. Note that each software module is stored in the HDD 204 illustrated in FIG. 2A and loaded into the RAM 203 and executed by the CPU 201. A transceiver unit 251 processes communication with the web browser of the client terminal 101 or the image forming apparatus 107 and the printing service, and exchanges data. A control unit 252 executes processing in accordance with a request received by the transceiver unit 251. A page generation unit 253 generates a web page for returning a response to the web browser. A settings management unit 254 manages various types of settings information relating to the CPS 104, information of cooperating external CPSs, and information of image forming apparatuses registered in the CPS 104. These various types of information are stored in a settings DB 257. An authenticating unit 255 authenticates users that send a login request to the CPS 104. The authenticating unit 255 also controls user authentication requests to an external CPS. The user account information of each CPS is stored in an authentication DB 258. A print management unit 256 performs control of storing print jobs received from the client terminal 101 and print jobs obtained from an external CPS in a print job DB 259. The print management unit 256 also executes image processing such as rendering on print jobs. A tenant management unit 260 manages the information of tenants existing in the CPS 104. The tenant information is stored in a tenant DB 261. Note that the CPSs105 and 106 may include hardware and software similar to that of the CPS 104. However, the corresponding protocols, functions provided, and the like may be different for each CPS.

### Settings Screen

Printer Registration Processing for CPS 104

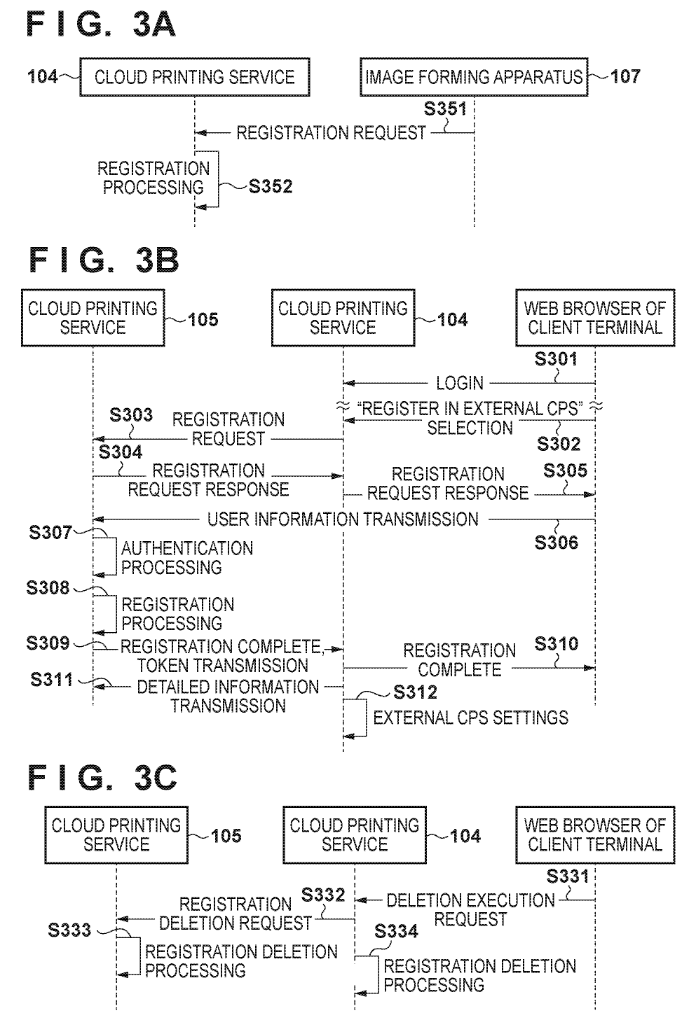

First, printer registration processing for the CPS 104 will be described using FIG. 3A. Note that in the following description, an image forming apparatus may be referred to as a printer. FIG. 3A illustrates an example of a sequence for registering a printer in the CPS 104. Here, a case where the image forming apparatus 107 is to be registered in the CPS 104 will be described. Note that in the description, the apparatus which is the entity performing each process is described, but more specifically, each process is implemented by the CPU (or processor) of the apparatus executing a program stored in memory.

In S351, the image forming apparatus 107 transmits a registration request to the CPS 104. The CPS 104 that receives a registration request in S352 registers the image forming apparatus 107 as a printer that can be used in its cloud printing service. When registration of the image forming apparatus 107 by the CPS 104 is complete, it becomes possible to perform printing, via the CPS 104, from the client terminal 101 installed with a print client corresponding to the CPS 104. In other words, a print job can be submitted from the client terminal 101 to the CPS 104 and held there, the held print job can be obtained by the image forming apparatus 107 and executed there to perform printing.

Note that in a case where a printer is to be registered with a specific tenant of a CPS, the image forming apparatus 107 and the CPS 104 perform S351 and S352 in association with the designated tenant. The association information of the CPS or the tenant and the printer is stored in a tenant information table 530 described below. The tenant information table 530 can be stored in the tenant DB 261 and can be accessed via the tenant management unit 260.

CPS 104 Registration Processing for External CPS

Next, a settings screen for when executing processing to register the CPS 104 in an external CPS will be described using FIGS. 3B and 4A to 6B.

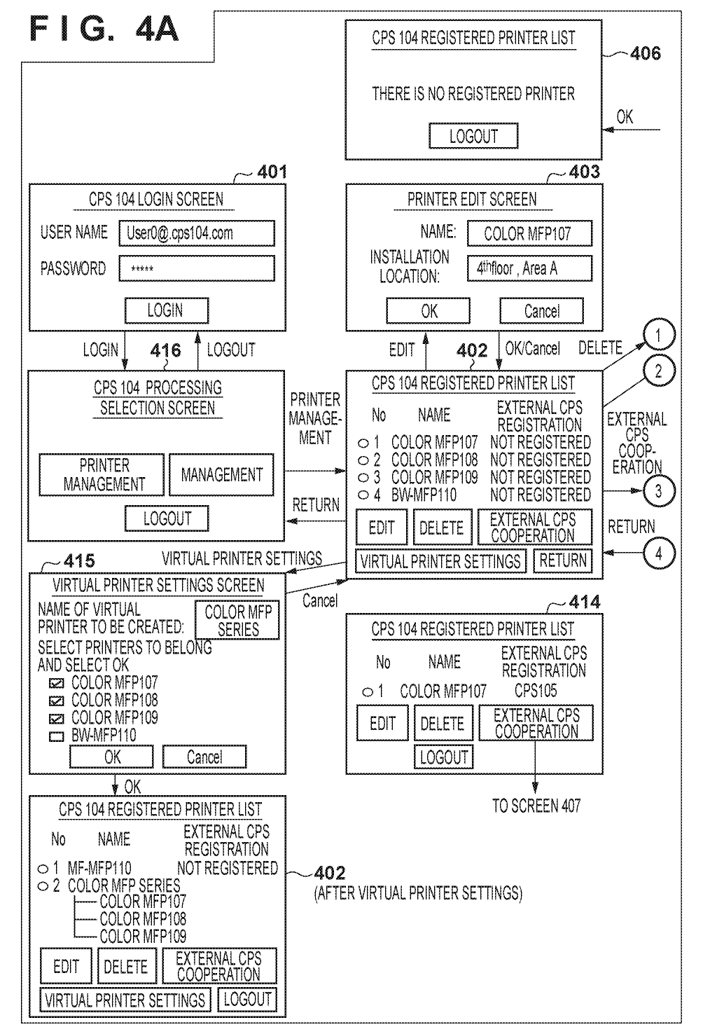

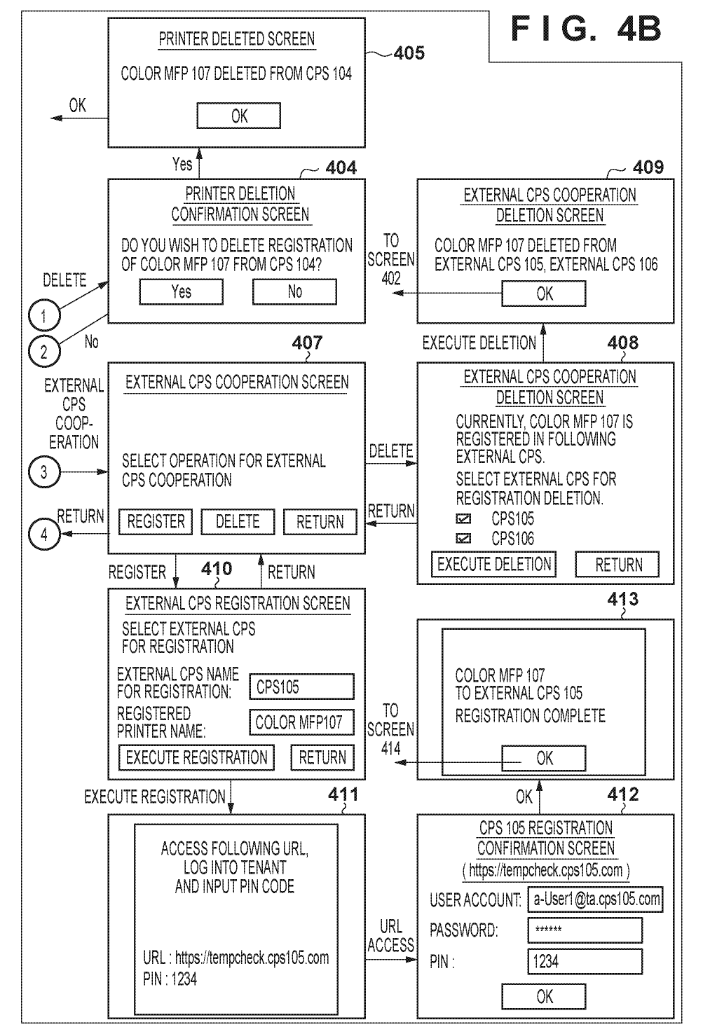

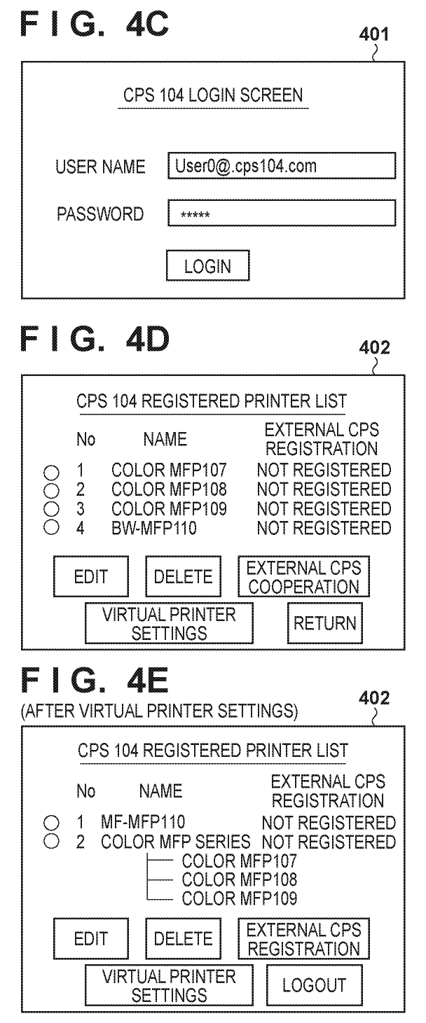

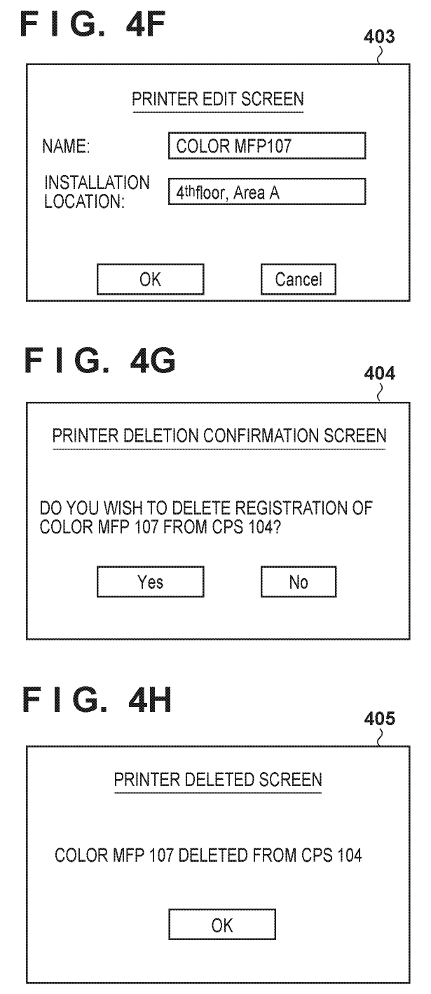

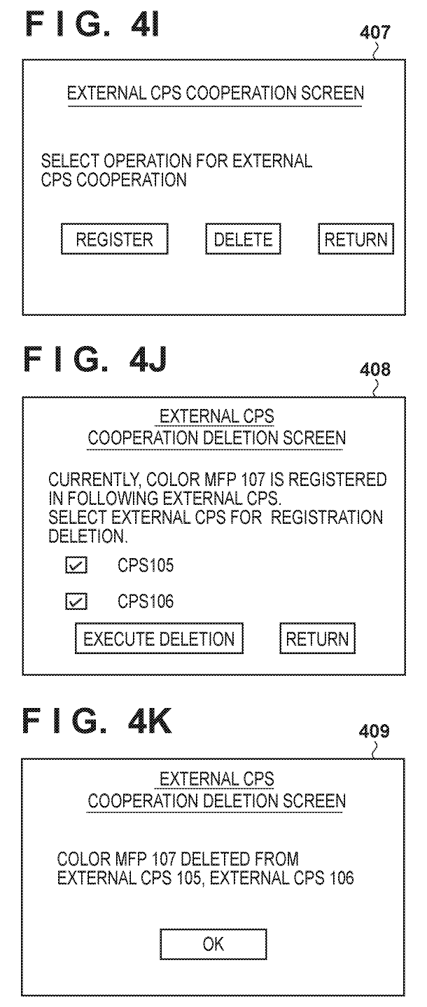

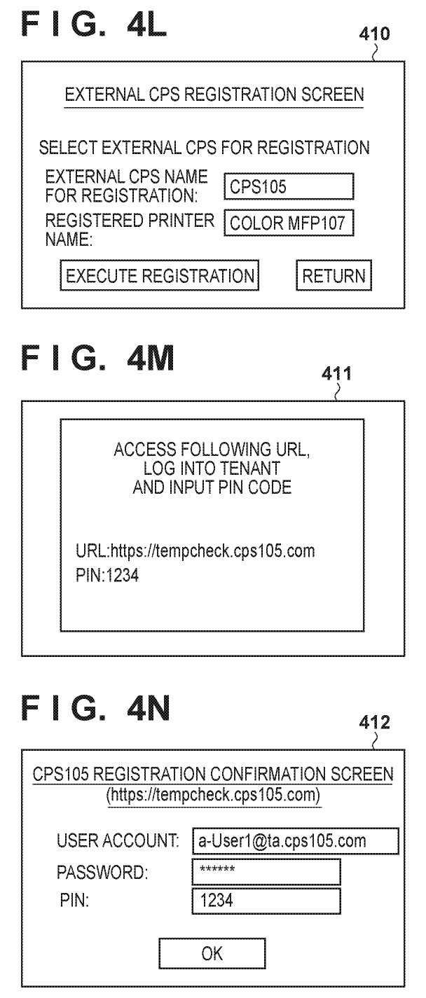

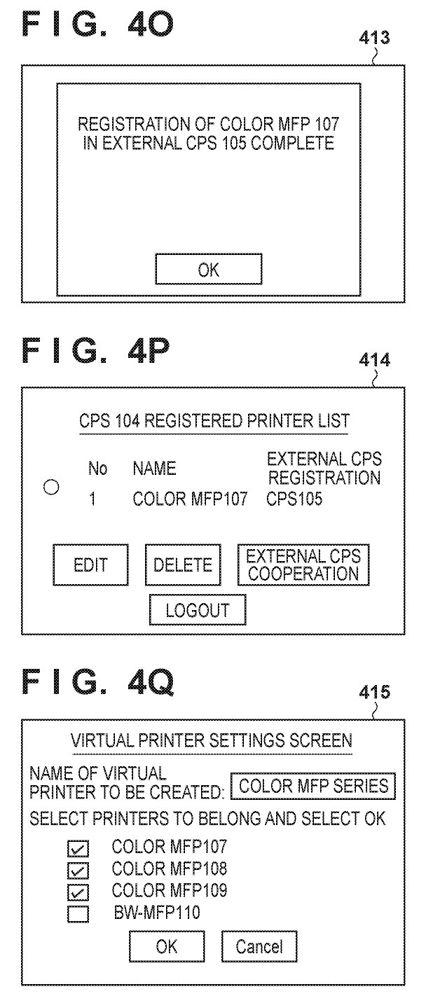

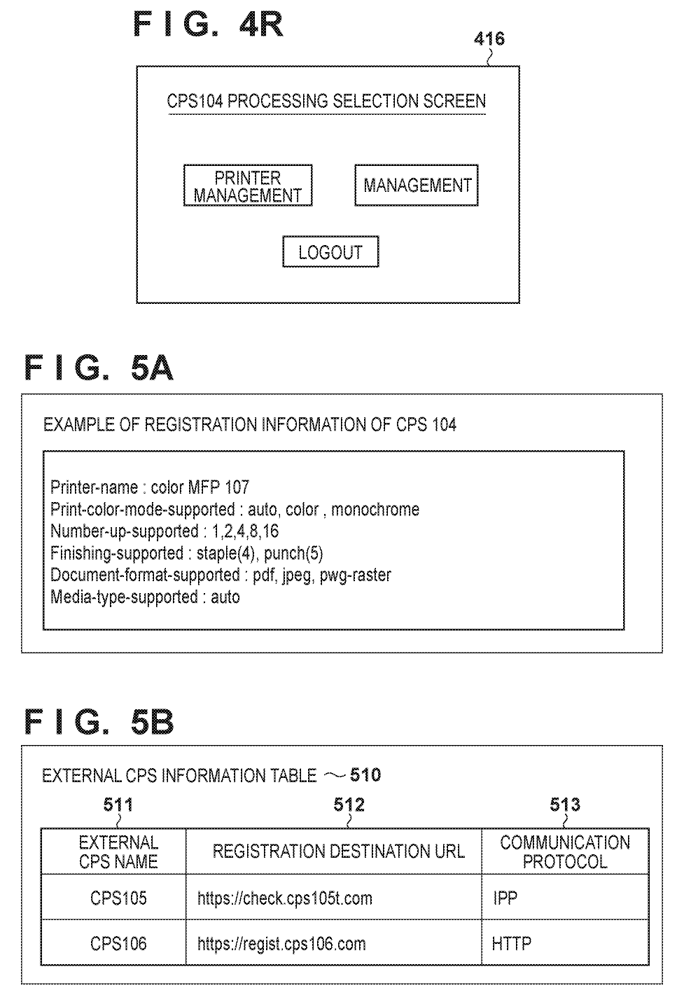

FIGS. 4A and 4B illustrate examples of transitions of screens provided by the CPS 104, and when an administrator accesses and operates the screens from the web browser of the client terminal, the screens transition as illustrated in FIGS. 4A and 4B in accordance with this operation. FIGS. 4C to 4R are examples illustrating the details of each screen illustrated in FIGS. 4A and 4B. However, a registered printer screen 406 in a case where there is no registered printer in the CPS is omitted from FIGS. 4C to 4R.

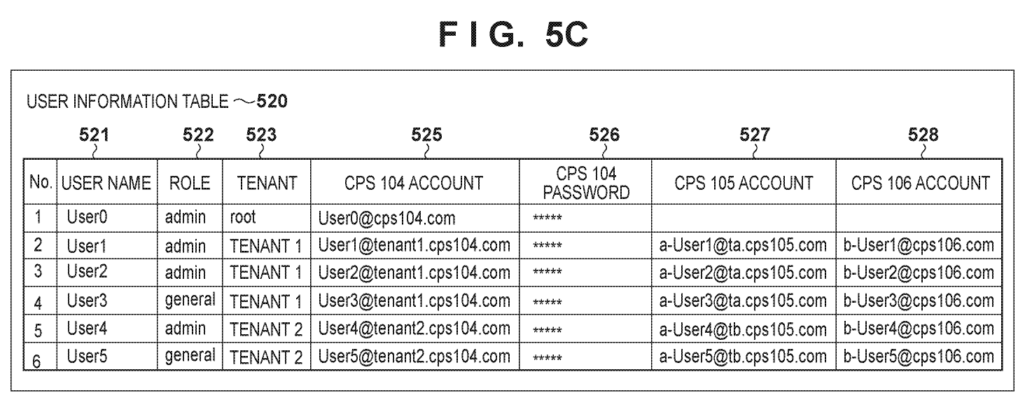

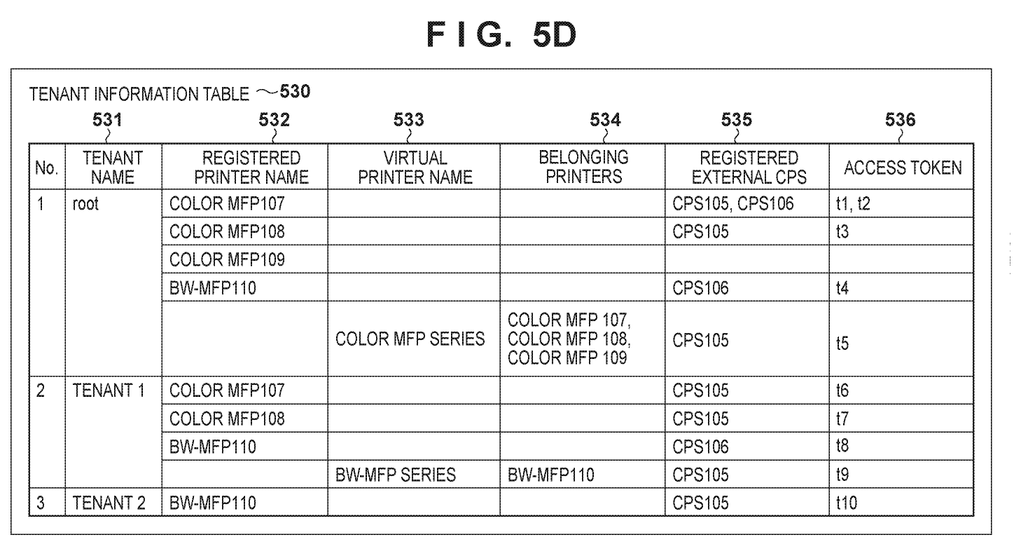

FIG. 5A illustrates an example of the CPS 104 registration information that the CPS 104 registers in the external CPS 105. FIG. 5B illustrates an external CPS information table 510 stored in the settings DB 257. The present table includes, for each cooperating external CPS, external CPS name 511, external CPS registration destination URL 512, and used communication protocol 513. This information may be able to be changed by the administrator.

FIG. 5C illustrates a user information table 520 stored in the authentication DB 258. The present table stores, for each user, the account information of the CPS 104 and the external CPS cooperating with the CPS 104. Specifically, included are user name 521, role 522, tenant 523, CPS 104 account 525, CPS 104 password 526, CPS 105 account 527, and CPS 106 account 528. However, no such limitation is intended. The CPS 104 account 525 and the CPS 104 password 526 are user information of the user of the CPS 104 that holds and manages the table. The CPS 105 account 527 and the CPS 106 account 528 are user information of the external CPS cooperating with the CPS 104. Note that “admin” and “general” indicated in the role 522 represent an administrator and a normal user of a tenant to which the user belongs, respectively. The values of the role and tenant of User0 are “admin” and “root”. In the present embodiment, the tenant “root” represents the entire CPS, and thus this represents User0 not belonging to a specific tenant and being the administrator of the entire CPS.

FIG. 5D illustrates the tenant information table 530. The tenant information table 530 includes, for each tenant, information relating to the registered image forming apparatuses. Hereinafter, image forming apparatuses may be referred to as printers. Tenant name 531 is identification information of the registered tenant. Registered printer name 532 is identification information of the image forming apparatuses registered with the tenant. Virtual printer name 533 is identification information of virtual printers in a case where the CPS and the like are registered in the CPS 104 as a virtual printer. Belonging printers 534 is identification information of image forming apparatuses that belong to the registered virtual printer. Registered external CPS 535 is identification information of the image forming apparatus registered in the CPS 104 or the external CPS in which the virtual printer is registered. Access token 536 is an access token used for accessing the external CPS.

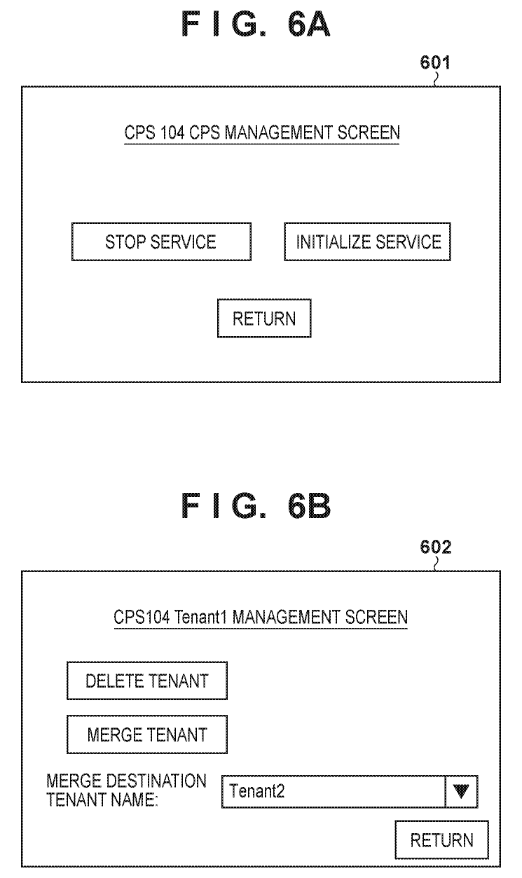

FIGS. 6A and 6B illustrate examples of a CPS management screen 601 and a tenant management screen 602, respectively, displayed on the client terminal.

Also, an administrator (for example, User0) of the CPS 104 trying to log into the CPS 104 accesses the predetermined URL of the web server of the CPS 104 from the web browser of the client terminal. The web server is a server that responds to requests from the web browser and may include the transceiver unit 251 and the control unit 252, for example. The transceiver unit 251 of the CPS 104 that receives the access request transfers the received data to the control unit 252. The control unit 252 interprets the access request, generates response data at the page generation unit 253, and transmits a login screen 401 illustrated in FIGS. 4A and 4C to the client terminal via the transceiver unit 251.

FIG. 3B is a sequence diagram for registering the CPS 104 in the external CPS 105. FIG. 3B starts at the login screen 401.

On the login screen 401, the administrator inputs user information including the administrator user name and password pre-registered in the CPS 104. In S301, the client terminal transmits the user information including the user name and password input for the CPS 104, and the CPS 104 receives these. The control unit 252 of the CPS 104 looks up the input user information in the user information table 520 and determines whether or not authentication is successful. If authentication is successful, the CPS 104 transmits a processing selection screen 416 illustrated in FIGS. 4A and 4R to the web browser of the client terminal, and the processing selection screen 416 is displayed on the web browser. The process from here to the registration in the external CPS will now be described, but this process is omitted in FIG. 3B.

When the user selects “Printer management” on the processing selection screen 416, a request in accordance with the current state and selection is transmitted from the web browser to the web server of the CPS 104. The web server that receives this transmits the screen information of a registered printer list screen 402 to the web browser. Accordingly, the registered printer list screen 402 illustrated in FIGS. 4A and 4D is displayed on the web browser of the client terminal. Via the registered printer list screen 402, the administrator can operate settings changes and processing to register in the external CPS, and the CPS 104, in response to this operation, performs control while changing the stored contents of the settings DB 257 in the settings management unit 254.

Note that the screen transitions described here may be implemented by screens corresponding to the screen information sent as a response by the web server of the CPS 104 to a request to transmit in response to the screen information displayed by the web browser and an input. The processing by the CPS 104 is also executed in response to a request to transmit in response to screen information displayed by the web browser and an input. However, the requests and responses between the web browser and the web server will not be described here.

The description will return to the registered printer list screen 402 displayed in a case where “Printer management” is selected on the processing selection screen 416. As indicated in No. 1 of the tenant information table 530 illustrated in FIG. 5D, the image forming apparatus 107 to the image forming apparatus 110 have already been registered in the CPS 104 using the registration process of FIG. 3A. In this case, the registered printer list screen 402 represents this state. In other words, a print job can be submitted to the image forming apparatus 107 to the image forming apparatus 110 via the CPS 104 if the client terminal corresponds to the CPS 104 and the user belongs to the tenant name root. “Name” on the registered printer list screen 402 corresponds to the printer name of the image forming apparatuses 107 to 110 registered in the CPS 104 and is a value stored in the registered printer name 532. This is the name displayed when a printer search is performed from the client terminal. The field “Registered External CPS” 535 is a field indicating whether the image forming apparatus is registered in the external CPS. When a certain image forming apparatus is registered in the external CPS, the external CPS name is registered in the registered external CPS 535. Also, access token information for accessing the registered external CPS is registered in Access token 536.

### Registration Processing

In the present processing, in the CPS 104, the User0, who is an administrator of the entire CPS, is assumed to be logged in. On the registered printer list screen 402, in a state where a specific printer including a virtual printer is selected, when “External CPS cooperation” is selected, an external CPS cooperation screen 407 illustrated in FIGS. 4B and 4I is transitioned to. On the external CPS cooperation screen 407, when “Register” is selected, an external CPS registration screen 410 illustrated in FIGS. 4B and 4L is transitioned to. The external CPS registration screen 410 is an example of a screen for selecting which external CPS to register the CPS 104 in. In this example, the external CPS for registration is set to the CPS 105, the printer name for registration is set to “Color MFP 107”, and “Execute registration” is selected.

In response to this operation, in S302, the web browser of the client terminal transmits, to the web server of the CPS 104, information indicating each image forming apparatus to be registered with the external CPS as well as a request (input information) to execute registration with the CPS 105 external CPS.

The control unit 252 of the CPS 104 that receives the input information references the external CPS information table 510 stored in the settings DB 257 via the settings management unit 254 and references the registration destination URL of the CPS 105. Accordingly, as the registration URL of the CPS 105 is known to be “https://check.CPS105.com”, in S303, the control unit 252 of the CPS 104 transmits a printer registration request to this destination. In this request, information of the image forming apparatus to be registered may be included.

In S304, the CPS 105 that receives the registration request responds with the URL for inputting the authentication information and a temporary password (in the present embodiment, a PIN code) for authentication. The control unit 252 of the CPS 104 that receives the response from the CPS 105, transmits, in S305, an authentication information input screen 411 illustrated in FIGS. 4B and 4M to the web browser of the client terminal. The administrator who checks the authentication information input screen 411 opens the displayed URL on the web browser and inputs user information such as the account information registered in the CPS 105 as in the case of a registration confirmation screen 412 illustrated in FIGS. 4B and 4N. In S306, the web browser of the client terminal transmits the input user information to the external CPS, which in this example is the CPS 105.

In S307, the CPS 105 that receives the user information executes authentication processing. If authentication success is determined, in S308, the CPS 105 executes registration processing for the request received in S303. Also, in S309, the CPS 105 transmits a registration-success response to the CPS 104 and access token information to be used in the subsequent communication to the CPS 104. In S310, the control unit 252 of the CPS 104 that receives the registration-success response transmits a registration complete screen 413 illustrated in FIGS. 4B and 4O to the web browser of the client terminal. The web browser that receives this screen displays it. Thereafter, in S311, the control unit 252 of the CPS 104 transmits detailed information to the CPS 105, and the CPS 105 executes detailed printer information registration processing based on the received detailed information. A communication protocol 513 of the external CPS information table 510 of FIG. 5B can be referenced to learn that the CPS 105 uses IPP as the communication protocol. Thus, the CPS 104 can transmit detailed information in the IPP format to the CPS 105 as in FIG. 5A. Lastly, in S312, the control unit 252 of the CPS 104 sets the CPS 105 in the registered external CPS 535 of the tenant information table 530.

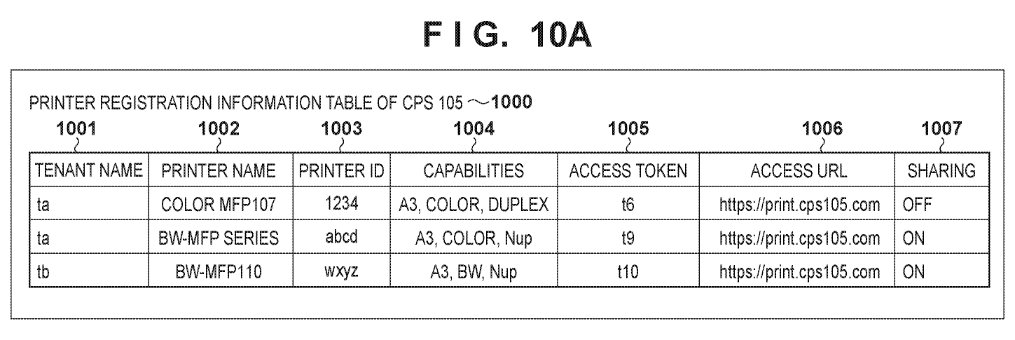

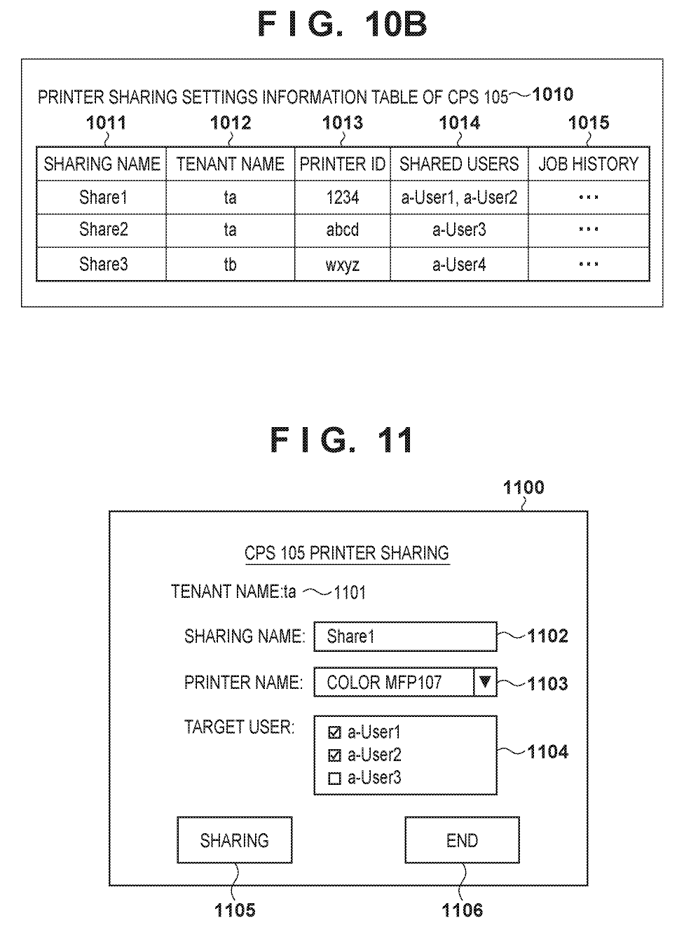

The CPS 105 that receives the registration request registers the printer to be registered in a printer registration information table 1000 illustrated in FIG. 10A, for example. The printer registration information table 1000 includes tenant name 1001 that the printer belongs to, printer name 1002, printer ID 1003, capabilities 1004, access token 1005, access destination URL 1006, and sharing 1007. These may be included in the printer detailed information described above.

Note that when the OK button is selected on the registration complete screen 413, a registered printer list screen may be returned to. In a case where the example registration described above has been completed, as with a registered printer list screen 414 illustrated in FIGS. 4A and 4P, a screen including information of an image forming apparatus and information of the external CPS where it is registered is displayed.

As described above, processing to register the image forming apparatus 107 registered in the CPS 104 in the external CPS 105 has been completed as illustrated with the registered printer list screen 414 of FIG. 4P. By registering the information of the image forming apparatus 107 in the external CPS 105 as illustrated in FIG. 5A, the external CPS 105 now cannot distinguish between the registered printer being an actual image forming apparatus and a CPS and treats them the same. Accordingly, for example, when the CPS 104 provides a print job or information relating to the print job to the image forming apparatus 107, the CPS 104 can obtain the print job held by the cooperating external CPS 105 or the information relating to the print job from the CPS 105. Also, the CPS 104 can provide the image forming apparatus 107 with the obtained print job or information relating to the print job. Note that even in a case where a virtual printer “color MFP series” is selected and “External CPS cooperation” is selected on the registered printer list screen 402 illustrated in FIG. 4E, a sequence similar to the image forming apparatus registration sequence is executed. In this case, in S311, the detailed information of the printer transmitted to the external CPS 105 may be an AND condition or an OR condition of the capabilities of the image forming apparatus belonging to the present virtual printer. This may also be selected via the settings.

As described in the example described above, the user trying to log into the screen 401 is a user with the tenant name “root”. However, a user belonging to any tenant may log in.

In this case, the processing of each screen is executed using information of the corresponding tenant in the tenant information table 530. For example, in a case where User1 logs in on the screen 401, the processing of each screen is executed relating to tenant1.

### Other Processing and Screens

From the processing selection screen 416 of FIGS. 4A and 4R, other processing which is not related to operations and processing to register an image forming apparatus or CPS in an external CPS can be selected. For example, when “Management” is selected, a CPS management screen 601 of the CPS 104 illustrated in FIG. 6A or a tenant management screen 602 illustrated in FIG. 6B is displayed. When an administrator with the tenant “root” logs in on the login screen 401, the CPS management screen 601 is displayed, and when an administrator of any tenant logs in, the tenant management screen 602 is displayed. The processing of the CPS management screen 601 and the tenant management screen 602 will be described below.

When “Edit” of the registered printer list screen 402 is selected, a printer edit screen 403 illustrated in FIGS. 4A and 4F is transitioned to, and registered printer information can be edited. For example, the printer name and installation location can be edited.

Also, when “Delete” is selected with a specific printer selected on the registered printer list screen 402 of FIGS. 4A and 4D, a printer deletion confirmation screen 404 illustrated in FIGS. 4B and 4G is transitioned to. When execute deletion (a touch of the illustrated “YES” button) is selected on the printer deletion confirmation screen 404, the record corresponding to the selected printer is deleted from the tenant information table 530. Also, a printer deleted screen 405 is transitioned to, and that the printer has been deleted from the CPS 104 is displayed on the printer deleted screen 405 illustrated in FIGS. 4B and 4H.

Also, for example, in a case where the administrator wishes to group color MFPs together and create a virtual printer, when “Virtual printer settings” on the registered printer list screen 402 is selected, a virtual printer settings screen 415 illustrated in FIGS. 4A and 4Q is transitioned to. The virtual printer settings screen 415 is a screen for setting the name of the virtual printer to be created and which printers to group together. Here, a virtual printer named “Color MFP series” is to be created from a group including the color MFPs 107, 108, and 109. When creation is complete, as illustrated on the registered printer list screen 402 (after virtual printer settings), the virtual printer is registered under the name “Color MFP series” in the virtual printer name 533 of the tenant information table 530. Also, the information of the printer belonging to the virtual printer is stored in the belonging printers 534.

Note that as described in the example described above, the user trying to log into the login screen 401 is a user with the tenant name “root”. However, a user belonging to any tenant may log in.

In this case, the processing of each screen is executed using information of the corresponding tenant in the tenant information table 530. For example, in a case where User1 logs in on the screen 401, the processing of each screen is executed relating to tenant1.

The processing executed in conjunction with deleting a registered printer including CPS initialization and service stoppage and tenant deletion and merge will be described below.

### Registration Deletion Processing

In the present processing also, in the CPS 104, the User0, who is an administrator of the entire CPS, is assumed to be logged in. Also, the external CPS 105 is used as an example of the external CPS.

A deletion processing sequence indicated on the screen 404 and a screen 408 illustrated in FIGS. 4B and 4K will now be described using FIG. 3C. In a case where the administrator wishes to delete a registered printer from the CPS 104, they select the printer or virtual printer they wish to delete on the registered printer list screen 402 and select “Delete”. In S331, the web browser of the client terminal transmits information indicating the printer or virtual printer selected in response together with a deletion execution request to the CPS 104.

The control unit 252 of the CPS 104 that receives the deletion execution request determines whether or not the printer or virtual printer is already registered in the external CPS 105. In this example, it is already registered in the external CPS 105. In this case, as it is already registered, the information of the registered printer of the CPS 104 registered in the external CPS 105 first needs to be deleted. Thus, in S332, the control unit 252 of the CPS 104 transmits, of the information of the registered printer or virtual printer, a deletion request for information of the printer or virtual printer requested to be deleted to the CPS 105. For example, for the deletion request, an IPP Deregister-Output-Device operation, a HTTP DELETE method, or a similar method may be used. Since the printer ID or registration ID is stored in the request, the external CPS 105 that receives the deletion request can identify the printer or virtual printer to be deleted.

In S333, the CPS 105 that receives the deletion request executes processing to delete the printer. Here, for example, the record of the printer to be deleted may be deleted from the printer registration information table 1000. After the deletion request is transmitted to the CPS 105, the control unit 252 of the CPS 104 deletes the information of the printer or virtual printer selected from the settings DB 257. Also, in S334, the control unit 252 of the CPS 104 deletes the information of the printer to be deleted from the tenant information table 530. If it is not registered in the external CPS, the processing of S332 and S333 is skipped.

In a case where the administrator wishes to delete the registration of the selected printer or virtual printer from the external CPS without deleting it from the CPS 104, on the external CPS cooperation deletion screen 408 illustrated in FIGS. 4B and 4J, in the processing of S334, the record of the designated printer is not deleted. Instead of deletion of the record of the designated printer, for the selected printer, the registered external CPS 535 and the access token 536 corresponding to the registered external CPS 535 are deleted.

As described in the example described above, the user trying to log into the screen 401 is a user with the tenant name “root”. However, a user belonging to any tenant may log in. In this case, the processing of each screen is executed using information of the corresponding tenant in the tenant information table 530. For example, in a case where User1 logs in on the screen 401, the processing of each screen is executed relating to tenant1.

As described above, deletion processing for a printer or virtual printer can be implemented without inconsistency across cooperating CPSs even when there is a cooperating external CPS.

### CPS Stoppage Processing and Initialization Processing

Next, service stoppage and initialization processing for the CPS 104 will be described, focusing in particular on the handling of registration to the external CPS. In the present processing, an administrator with permission to stop and initialize the service of the CPS 104, for example, an administrator of the entire CPS with the role “admin” (administrator) and the tenant “root”, needs to be logged into the CPS 104.

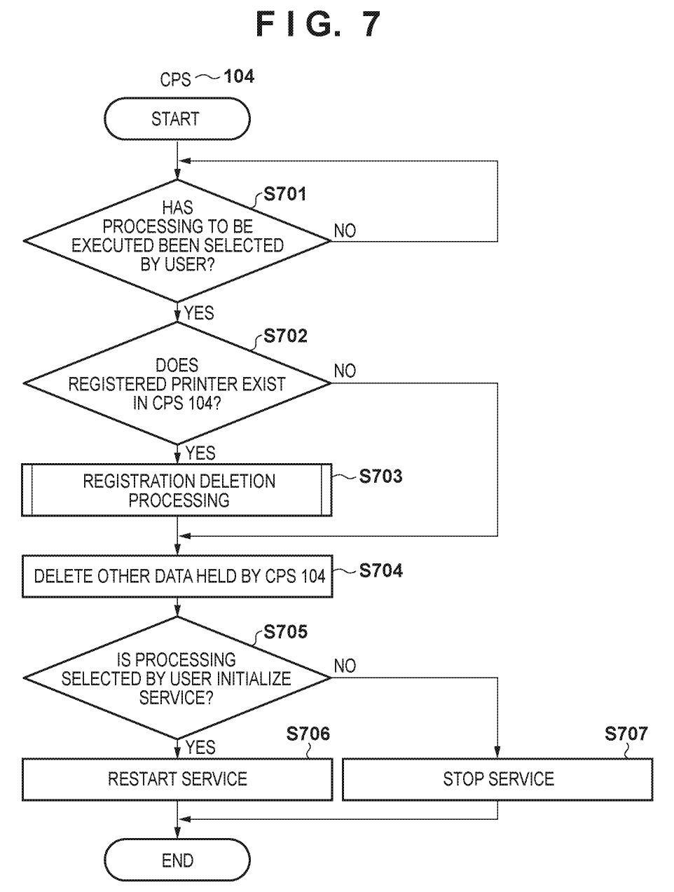

When an administrator with the tenant “root” logs in and selects “Management” on the processing selection screen 416 of the CPS 104, the CPS management screen 601 of FIG. 6A is displayed. On the CPS management screen 601, a “Stop service” button for stopping the service of the CPS 104, an “Initialize service” button for initializing the CPS 104, and a “Return” button for returning to the processing selection screen 416 are disposed. Here, the processing by the CPS 104 when the administrator presses the “Stop service” button or the “Initialize service” button will be described using the flowchart of FIG. 7. Note that an operation by the user is performed on the client terminal, the operation content is transmitted to the CPS 104, and the CPS 104 executes the processing. However, as the following description relates to the processing in the CPS 104, description of the input performed on the client terminal will be omitted.

When the administrator selects any button on the screen 601, in S701, the control unit 252 of the CPS 104 determines whether “Stop service” or “Initialize service” has been selected. In S702, the control unit 252 of the CPS 104 determines whether or not a registered printer exists in the CPS 104. In S702, the control unit 252 determines whether or not one or more printers are registered in the registered printer name 532 of the tenant information table 530.

In S702, in a case where it is determined that one or more printers are registered, the processing advances to S703. Otherwise, the processing advances to S704.

In S703, the control unit 252 executes the registration deletion processing for all of the registered printers and virtual printers registered in the CPS 104. At this time, the registered printers and virtual printers registered in the external CPS are also deleted from the external CPS. The registration deletion processing is similar to the processing of S332 to S334 of FIG. 3C. However, the printers to be deleted are all of the registered printers and virtual printers registered in the CPS 104.

Thereafter, in S704, the control unit 252 deletes the various types of information managed by the CPS 104 in preparation for the initialization or stoppage of service. For example, the information held in the external CPS information table 510 and the user information table 520 and the like are deleted.

Next, in S705, the control unit 252 determines what the processing selected by the administrator is. In a case where “Initialize service” has been selected, the processing branches to S706, and in a case where “Stop service” has been selected, the processing branches to S707. In a case where the administrator has selected “Initialize service”, in S706, the control unit 252 restarts the service. Since the various types of information of the CPS 104 have been deleted in S703 and S704, after the restart, the service is initialized. In a case where the administrator has selected “Stop service”, in S707, the control unit 252 stops the service. Since the various types of information of the CPS 104 have been deleted in S703 and S704, the service can be safely stopped.

This ends the description of the present flowchart.

Even in a case where the CPS service is stopped or restarted in this manner, the image forming apparatuses including virtual printers registered in the CPS 104 are deleted before service stoppage or restart. Also, if an image forming apparatus including a virtual printer registered in the CPS is registered in the external CPS cooperating with the CPS, the image forming apparatus is deleted from the cooperating external CPS. In this manner, the information of the registered image forming apparatuses can be made consistent across cooperating CPSs, and faults caused by inconsistency can be prevented or reduced.

### Tenant Deletion Processing

Next, deletion processing for tenants of the CPS 104 will be described. In the present processing, an administrator of the entire CPS or an administrator with a tenant to be deleted needs to be logged into the CPS 104.

When the administrator with a tenant to be deleted selects “Management” on the processing selection screen 416 of the CPS 104, the tenant management screen 602 of the CPS illustrated in FIG. 6B for managing the tenant to be deleted is displayed. On the tenant management screen 602, a “Delete tenant” button and a “Merge tenant” button are disposed. Also, a “Merge destination tenant” may be disposed for designating the merge destination tenant as a related item of the “Merge tenant” button. Note that in a case where the administrator of the entire CPS is logged in, a tenant selection screen (not illustrated) is displayed before advancing to the present screen. When a tenant which is the operation target is selected on the tenant selection screen, the screen 602 is displayed.

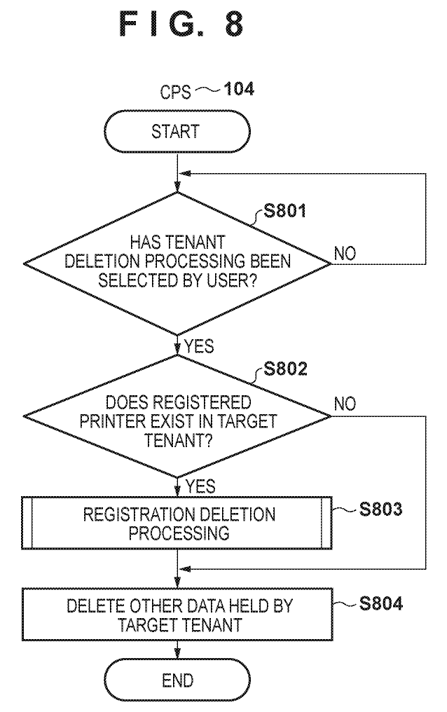

Also, the processing executed when the administrator presses the “Delete tenant” button will be described using the flowchart of FIG. 8. In this example, “Tenant1” is selected as the tenant to be deleted. Note that the processing executed when the “Merge tenant” button is pressed will be described below.

When the administrator selects the processing on the screen 602, in S801, the control unit 252 of the CPS 104 determines whether or not the selected processing is “Delete tenant”. In a case where “Delete tenant” is selected, the processing branches to S802. In a case where processing other than “Delete tenant” is selected, the processing loops to S801 as in FIG. 8. However, this is to facilitate description, and whether or not a different selection, for example, “Merge tenant”, has been selected may be determined. Also, though not illustrated, in a case where it is determined that “Return” has been selected, the processing selection screen 416 is returned to.

In S802, the control unit 252 determines whether or not a registered printer exists in tenant1. In S802, the control unit 252 determines whether or not one or more printers of tenant1 are registered in the registered printer name 532 of the tenant information table 530. In a case where it is determined that one or more printers are registered in tenant1, the processing advances to S803. Otherwise, the processing advances to S804.

In S803, the control unit 252 executes the registration deletion processing for all of the registered printers and virtual printers registered in tenant1. The registration deletion processing is similar to the processing of S332 to S334 of FIG. 3C. However, the printers to be deleted are the registered printers and virtual printers registered in tenant1. At this time, the registered printers and virtual printers registered in the external CPS are also deleted from the external CPS.

Thereafter, in S804, the control unit 252 deletes the information of tenant1 from the CPS 104. For example, information relating to tenant1 held in the user information table 520 and the tenant information table 530 is deleted.

This ends the description of the present flowchart. Note that since the information of the tenant to be deleted is deleted in S804, in S803, S334 of FIG. 3C may not be executed and only S332 to S333 may be executed. Via the deletion processing described above, conformity in registration is maintained by deleting, of the image forming apparatuses registered in the tenant that are deleted from the CPS 104, the image forming apparatuses registered in the external CPS also from the external CPS. Thus, faults caused by inconsistency in the registration information can be prevented or reduced.

### Tenant Merge Processing

Next, merge processing for tenants of the CPS 104 will be described. In the present processing, an administrator of the entire CPS or an administrator with a tenant to be merged needs to be logged into the CPS 104.

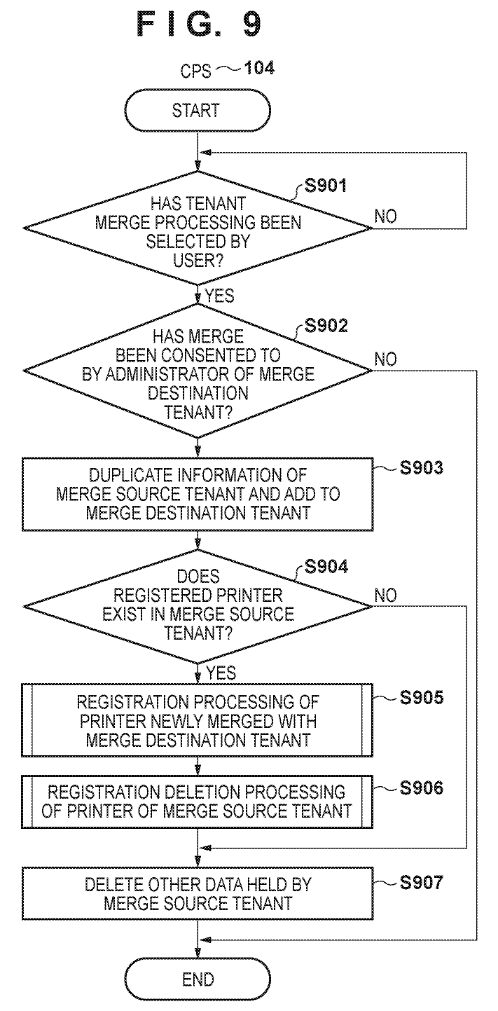

Also, the processing executed when the administrator presses the “Merge tenant” button in a state where the tenant management screen 602 is displayed will be described using the flowchart of FIG. 9 in a similar manner to the case of “Tenant deletion processing”. In this example, “Tenant2” is selected by the administrator of tenant1 as the merge destination tenant. In other words, the merge source tenant is “Tenant1”, and the merge destination tenant is “Tenant2”. The merge source tenant is the merged tenant which disappears after merge, and the merge destination tenant is a merge tenant that survives after merge.

When the administrator selects the processing on the screen 602, in S901, the control unit 252 of the CPS 104 determines whether or not the selected processing is “Merge tenant”. In a case where “Merge tenant” is determined, the processing branches to S902. Otherwise, the processing loops at S901 as illustrated in FIG. 9, but this is to facilitate description, and the processing may branch to S801. Also, though not illustrated, in a case where it is determined that “Return” has been selected, the processing selection screen 416 is returned to.

In S902, the control unit 252 sends a merge consent request for tenant1 to the administrator of the merge destination tenant “Tenant2”, waits for a response, and when received, determines whether or not the response is consent for merge. For the merge consent request, email may be used or the merge consent request may be displayed on a web page via the page generation unit 253 when the administrator of “Tenant2” logs into the CPS 104. In a case where it is determined that merge consent has been obtained, the processing branches to S903. In a case where it is determined that merge consent has not been obtained, the processing may end. In this case, a screen indicating non-consent may be displayed, and in this case, the tenant management screen 602 may be returned to after the screen indicating non-consent.

In a case where it is determined that merge consent has been obtained from the administrator of “Tenant2”, in S903, the control unit 252 duplicates the information of tenant1 and then adds it to the information of tenant2. Specifically, the control unit 252 duplicates the record with “Tenant1” for the tenant 523 in the user information table 520, the tenant 523 is rewritten to “Tenant2” and added to the user information table 520. Also, for tenant 531 of the tenant information table 530, in a similar manner, the information of tenant1 is duplicated and then added to the information of tenant2. Specifically, the control unit 252 duplicates the record with “Tenant1” for the tenant name 531 in the tenant information table 530, the tenant name 531 is rewritten to “Tenant2” and added to the tenant information table 530. At this time, a list in which the information of the merge source tenant1 and the information of the merge destination tenant2 are associated together (or association information) is temporarily held in the tenant DB 261.

In S904, the control unit 252 references the tenant information table 530 and determines whether or not a registered printer or virtual printer exists in the merge source tenant (merged tenant). In a case where it is determined that a registered printer or virtual printer exists, the processing branches to S905, and in a case where it is determined that they do not exist, the processing branches to S907.

In S905, the control unit 252 executes registration processing for the printer newly added to the merge destination tenant (surviving tenant) in S903. The printer registration processing is similar to the processing from S303 to S311 of FIG. 3B. However, the printer to be registered is the printer added to the merge destination tenant in S903. Also, the client terminal is the terminal where the merge tenant instruction was input.

Next, in S906, the control unit 252 executes registration deletion processing for the printer of the merge source tenant “Tenant1”. The registration deletion processing is similar to the processing of S332 to S334 of FIG. 3C. However, the printer to be deleted is a printer belonging to the merge source tenant. Thereafter, in S907, the control unit 252 deletes the information of tenant1 from the CPS 104. For example, information relating to tenant1 held in the user information table 520 and the tenant information table 530 is deleted.

This ends the description of the present flowchart. Note that since the information of the tenant to be deleted is deleted in S804, in S803, S334 of FIG. 3C may not be executed and only S332 to S333 may be executed. Via the deletion processing described above, conformity in registration is maintained by deleting, of the image forming apparatuses registered in the tenant that are deleted from the CPS 104, the image forming apparatuses registered in the external CPS also from the external CPS. Thus, faults caused by inconsistency in the registration information can be prevented or reduced.

By executing the processing described above, even in a case where a status change occurs in the CPS, the printer registration information registered in the external CPS can be appropriately deleted or post-deletion re-registration can be appropriately performed.

### Second Embodiment

In the first embodiment described above, for example, in conjunction with a status change in the CPS, printer registration to an external CPS and printer deletion from the external CPS are appropriately adjusted. However, in a case where processing labelled “Tenant merge processing” is executed, by only deleting printer registration information of the merged tenant that was registered in the external CPS, printer sharing settings information for receiving a print job at the external CPS is left to remain. In the present embodiment described herein, for example, in conjunction with the tenant merge processing of the CPS, not only the printer registration information but also the printer sharing settings information of the external CPS can be merged. In the following description, the differences from the first embodiment will be focused on.

FIGS. 10A and 10B illustrate examples of tables managed in the external CPS 105. Note that in the present embodiment, the CPS 105 has a similar software configuration to the CPS 104. However, the CPS 105 may be different from the CPS 104 in terms of the supported protocols, provided functions, detailed configuration, and the like. Also, the table configurations of FIGS. 10A and 10B are examples, and a table configuration different from that of the present example may be used.

FIG. 10A illustrates the printer registration information table 1000 which includes, for each registered printer, the tenant name 1001, the printer name 1002, the printer ID 1003, the capabilities 1004, the access token 1005, the access URL 1006, and the sharing 1007. One record represents one piece of printer registration information. The printer registration information table 1000 of FIG. 10A may have the same configuration as that described in the first embodiment. However, for the sharing 1007, it may not be provided in the first embodiment and may be specific to the present embodiment.

The tenant name 1001 is the name of the tenant that the printer registered in the external CPS 105 belongs to. The printer name 1002 is the printer name of the registered printer. The printer ID 1003 is a printer ID unique for each printer. The capabilities 1004 represent the capabilities of the printer. In a case where the printer has a plurality of capabilities, these are listed.

The access token 1005 and the access URL 1006 are represented by an access token and a URL used when the registered printer accesses the CPS 105. The sharing 1007 represents whether or not the registered printer is shared with users of the same tenant of the CPS 105. In this example, “ON” indicates that sharing is on, and “OFF” indicates that sharing is off, but no such limitation is intended.

FIG. 10B illustrates a printer sharing settings information table 1010 includes sharing name 1011, tenant name 1012, printer ID 1013, shared users 1014, and job history 1015. One record represents one piece of printer sharing settings information.

The sharing name 1011 is a name given by the administrator for opening and sharing the printer with users. The tenant name 1012 is the name of the tenant that the sharing settings belong to. The printer ID 1013 is a printer ID unique for each printer. In the printer ID 1013, a value for the printer ID 1003 of the printer registration information table 1000 associated with the sharing settings is stored. In the shared users 1014, a list of users, from among the users belonging to the tenant of the tenant name 1012, that the administrator has made targets for sharing of the printer in accordance with the sharing settings is stored. In the job history 1015, the history of print jobs printed via the sharing settings registered in the present table is stored. It is expected that printed date and time information, user name, document name, number of copies, and result are included in the job history, but no such limitation is intended.

FIG. 11 illustrates a printer sharing settings screen 1100 generated by the page generation unit 253 of the CPS 105. On the present screen, the administrator of each tenant performs settings for sharing the registered printer with users in the tenant. The screen 1100 includes tenant name 1101, sharing name 1102, printer name 1103, target user 1104, a share button 1105, and an end button 1106.

In the tenant name 1101, the tenant name that the administrator logged into the CPS 105 belongs to is displayed. The sharing name 1102 is a name for the sharing settings, and this can be freely input by the administrator. In the printer name 1103, the name of the printer to be shared is displayed in a drop-down list. In the values for the printer name 1002, listed are the printer names of printers with a tenant name that matches the tenant that the administrator belongs to. The operator can select their desired printer from here as the printer to be shared. In the target user 1104, the users that belong to the tenant name 1101 are displayed in a list. The operator can select one or more users from here as users for sharing of the printer to be shared.

When the administrator presses the share button 1105, printer sharing in accordance with the settings from the tenant name 1101 to the target user 1104 is executed. At this time, the value for the sharing name 1102 is stored in the sharing name 1011 of the printer sharing settings information table 1010. The value for the printer name 1103 is converted into a printer ID using the printer registration information table 1000 before being stored in the printer ID 1013. The value for the target user 1104 is stored in the shared users 1014. Also, the value for the sharing 1007 corresponding to the printer registration information table 1000 is set to “ON”. When the administrator presses the end button 1106, the settings are all discarded and the present screen is ended.

By the administrator making printers able to be shared among a plurality of users using the screen 1100, a sharing target user can execute printing with a shared printer via the CPS 105. The history of executions of printing is stored in the job history 1015. If a printer registered in the CPS 105 is, for example, a printer registered in a cooperating CPS such as the CPS 104, the printer registered in the CPS 104 can be shared by a plurality of users.

### Tenant Merge Processing

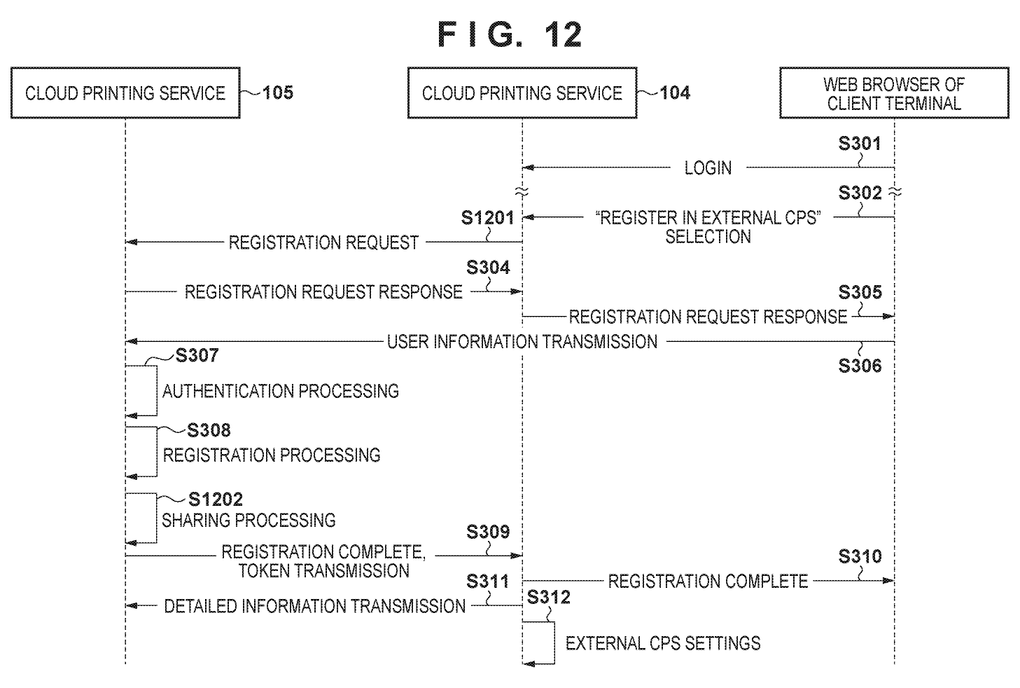

In a case where tenant merge processing according to the present embodiment is executed in the CPS 104, the flowchart of FIG. 9 is executed in a similar manner to the first embodiment. The registration processing executed in S905 after the execution of S901 to S904 will now be described using FIG. 12.

FIG. 12 illustrates a sequence for processing to register a printer in an external CPS according to the present embodiment. In FIG. 12, S301 to S312 are substantially the same as S301 to S312 of FIG. 3B except that S303 is substituted with S1201 and S1202 is added between S308 and S309. As described below, in the processing to register a printer in an external CPS, the process of FIG. 12 is the same as the process of FIG. 3B. However, in a case where the process is invoked from S905, S1201 to S311 are executed. The process of FIG. 12 in this case will now be described.

In S1201, the control unit 252 of the CPS 104 transmits a printer registration request to the CPS 105 as in S303. The printer to be registered is the printer added in S903 at the time of tenant merge. The printer to be registered is also the printer designated at the time of printer registration in the external CPS. At this time, a value for the access token 536 of the target printer in the merge source tenant is also provided to the printer registration request. The printer registration information of tenant2 of the merge destination is associated with the printer registration information of tenant1 of the merge source via the association list generated in S903. Thus, the access token can be identified. Note that in the processing to register a printer in the external CPS, an access token may not be provided. In other words, the processing may be same as S303 of FIG. 3B.

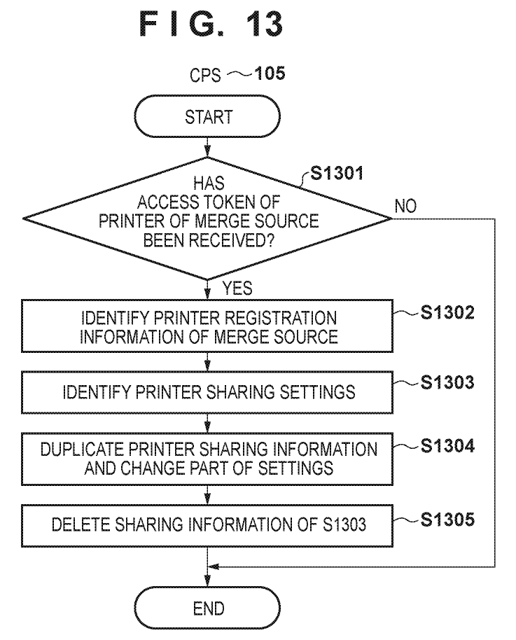

S1202 is processing executed after the registration processing of S308. In S1202, the CPS 105 sets the printer sharing settings for the printer added to the CPS 105 in S308 in accordance with the pre-merge printer sharing settings information. As described using FIG. 13, in S1202, if an access token has not been provided to the registration request, nothing is executed. Thus, in the processing to register a printer in an external CPS, the process of FIG. 12 is the same as the process of FIG. 3B. In other words, the registration request of a printer provided with an access token can be referred to as a tenant merge request to the CPS 105.

FIG. 13 is a flowchart describing the sharing processing of S1202 in detail. When the present flowchart is started, in S1301, the control unit 252 of the CPS 105 determines whether or not the registration request received in S1201 is provided with an access token of a printer of a merge source tenant. In a case where it is determined that an access token has been provided, the processing branches to S1302, and in a case where it is determined that an access token has not been provided, the processing ends. In S1302, the control unit 252 of the CPS 105 uses the printer registration information table 1000 and the access token to identify the printer registration information of the merge source tenant. Also, in S1303, the control unit 252 of the CPS 105 retrieves the value for the printer ID 1003 and compares it with that of the printer sharing settings information table 1010 to identify the printer sharing settings.

Next, in S1304, the control unit 252 of the CPS 105 duplicates the printer sharing settings identified in S1303 in the printer sharing settings information table 1010. At this time, the value for the tenant name 1012 is rewritten to the tenant name of the merge destination, and the value for the printer ID 1013 is rewritten to the printer ID set in the printer registration information registered in S308. The value for the shared users 1014 may be blank, and if an association table for the user information of the merge source and the merge destination is to be generated in advance, after conversion to the merge destination user information, the value may be stored. The control unit 252 of the CPS 105 exports the value for the job history 1015 from the merge source sharing settings information. In a case where the user information can be converted in a similar manner to the case of the shared users 1014, the user name in the exported job history is converted before being imported and merged into the job history 1015 of the merge destination sharing settings. In a case where the user information cannot be converted, the user information field is left blank. After execution of the processing described above, the value for the sharing 1007 of the corresponding printer registration information is changed to “ON”.

Lastly, in S1305, the control unit 252 of the CPS 105 deletes the printer sharing settings identified in S1303. At this time, the value for the sharing 1007 of the corresponding printer registration information in the printer registration information table 1000 also is changed to “OFF”.

In this manner, a printer newly registered in the merge destination tenant from the merge source tenant is registered, and for the printers being shared, the printer sharing information is updated in accordance with the merge destination tenant. This ends the description of the present flowchart.

Following on from the processing of S905, the control unit 252 of the CPS 105 executes S906 onward and ends the flowchart of FIG. 9. S906 may be the processing of S332 to S334 of FIG. 3C. With S906 and S907, the printer registration information of the merge source tenant is deleted, the associated information requiring deletion is also deleted, then the processing is ended.

By executing the processing described above, the external CPS 105 can merge not only the printer registration information but also the printer sharing settings information in cooperation with the tenant merge processing of the CPS 104.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-037709, filed March 10, 2025 which is hereby incorporated by reference herein in its entirety.

What is claimed is:

1. A first cloud printing system in which a registered printer registered in the first cloud printing system can be registered in a second cloud printing system, and in which a service of providing an input print job to the registered printer is performed, the first cloud printing system comprising:
at least one memory storing instructions; and
at least one processor that is in communication with the at least one memory and that, when executing the instructions, cooperates with the at least one memory to execute processing, the processing including
holding registration information including information indicating the registered printer and information indicating that the registered printer was registered from the first cloud printing system to the second cloud printing system;
receiving a request; and
in a case where the received request is a request involving deletion of the registered printer,
transmitting to the second cloud printing system a request to delete a printer registered in the second cloud printing system from among one or more deletion target printers, based on the registration information, and
deleting, from the registration information, registration information relating to the registered printer.

2. The first cloud printing system according to claim 1, the processing including
in a case where the received request involving deletion of the registered printer is a request to stop a service performed by the first cloud printing system or a request to initialize the first cloud printing system, transmitting to the second cloud printing system a request to delete a printer registered in the second cloud printing system from among one or more registered printers, based on the registration information, and
deleting, from the registration information, registration information relating to the registered printer.

3. The first cloud printing system according to claim 2, the processing including
in a case where the received request involving deletion of the registered printer is a request to stop a service performed by the first cloud printing system, stopping a service after the registration information relating to the registered printer is deleted from the registration information.

4. The first cloud printing system according to claim 2, the processing including
in a case where the received request involving deletion of the registered printer is a request to initialize a service performed by the first cloud printing system, restarting the service after the registration information relating to the registered printer is deleted from the registration information.

5. The first cloud printing system according to claim 1, wherein
the registration information includes the registration information for each tenant, and
the processing including
in a case where the received request involving deletion of the registered printer is a request to delete a tenant belonging to the first cloud printing system, transmitting to the second cloud printing system a request to delete a printer registered in the second cloud printing system, from among one or more registered printers belonging to the tenant, based on the registration information; and
deleting, from the registration information, registration information relating to the registered printer belonging to the tenant.

6. The first cloud printing system according to claim 5, the processing including
deleting information relating to the tenant after the registration information relating to the registered printer relating to the tenant is deleted from the registration information.

7. The first cloud printing system according to claim 1, wherein
the registration information includes the registration information for each tenant,
and the processing including
in a case where the received request involving deletion of the registered printer is a request to merge a merge source tenant belonging to the first cloud printing system with a merge destination tenant,
merging the registration information relating to the registered printer belonging to the merge source tenant with the merge destination tenant based on the registration information,
transmitting to the second cloud printing system a request to register, from among one or more registered printers merged with the merge destination tenant, a printer indicated by the registration information indicates in the second cloud printing system, and
transmitting to the second cloud printing system a request to delete a printer registered in the second cloud printing system from among one or more registered printers belonging to the merge source tenant, based on the registration information.

8. The first cloud printing system according to claim 7, the processing including
merging the registration information relating to the registered printer belonging to the merge source tenant with the merge destination tenant,
duplicating the registration information relating to the registered printer belonging to the merge source tenant based on the registration information,
rewriting the registration information relating to the registered printer that was duplicated as registration information relating to a registered printer belonging to the merge destination tenant and adding the rewritten registration information to the registration information held in the holding, and
deleting, from the registration information, the registration information relating to the registered printer belonging to the merge source tenant.

9. The first cloud printing system according to claim 1, the processing including
in a case where the received request involving deletion of the registered printer is a request to register a designated printer in the second cloud printing system, transmitting to the second cloud printing system a request to register a printer registered in the second cloud printing system, from among one or more designated printers, based on the registration information.

10. The first cloud printing system according to claim 1, the processing including
in a case where the received request is a request to register a designated printer in the first cloud printing system, adding registration information of the designated printer to the registration information held in the holding.

11. The first cloud printing system according to claim 1, wherein
the registration information includes, for the registered printer, sharing information indicating a user with whom the registered printer is shared.

12. A cloud cooperation system comprising:
a first cloud printing system in which a registered printer can be registered in a second cloud printing system, and in which a service of providing an input print job to the registered printer is performed; and
a second cloud printing system that cooperates with the first cloud printing system, wherein
the first cloud printing system includes
at least one memory storing instructions; and
at least one processor that is in communication with the at least one memory and that, when executing the instructions, cooperates with the at least one memory to execute processing, the processing including
holding registration information of each tenant including information indicating the registered printer and information indicating that the registered printer was registered from the first cloud printing system to the second cloud printing system;
receiving a request;
in a case where the request received is a request involving deletion of the registered printer,
transmitting to the second cloud printing system a request to delete a printer registered in the second cloud printing system from among one or more deletion target printers, based on the registration information, and
deleting, from the registration information, registration information relating to the registered printer;
in a case where the received request involving deletion of the registered printer is a request to merge a merge source tenant belonging to the first cloud printing system with a merge destination tenant,
merging the registration information relating to the registered printer belonging to the merge source tenant with the merge destination tenant based on the registration information,
transmitting to the second cloud printing system a request to register, from among one or more registered printers merged with the merge destination tenant, a printer for which registration in the second cloud printing system is indicated by the registration information, and
transmitting to the second cloud printing system a request to delete a printer registered in the second cloud printing system from among one or more registered printers belonging to the merge source tenant, based on the registration information, and
the second cloud printing system includes
at least one memory storing instructions; and
at least one processor that is in communication with the at least one memory and that, when executing the instructions, cooperates with the at least one memory to execute processing, the processing including
holding second registration information indicating a second registered printer registered in the second cloud printing system;
in a case where a request to register a printer is received from the first cloud printing system, registering the printer in the second registration information; and
in a case where a request to delete a printer is received from the first cloud printing system, deleting the printer from the second registration information.

13. The cloud cooperation system according to claim 12, wherein
the second cloud printing system further includes holding sharing information indicating a user with whom a printer registered in the second registration information is shared, and
the second cloud printing system includes, in a case where a tenant merge request is received from the first cloud printing system, rewriting, to a merge destination tenant, the sharing information relating to a printer belonging to a merge source tenant.

14. A non-transitory computer-readable storage medium storing a program that causes a computer to execute processing when loaded and executed on the computer, the processing including:
holding registration information including information indicating a registered printer and information indicating that the registered printer was registered from a first cloud printing system to a second cloud printing system;
receiving a request; and
in a case where the request received is a request involving deletion of the registered printer,
transmitting to the second cloud printing system a request to delete a printer registered in the second cloud printing system from among one or more deletion target printers, based on the registration information, and
deleting, from the registration information, registration information relating to the registered printer.

15. A printer management method by a first cloud printing system in which a registered printer registered in the first cloud printing system can be registered in a second cloud printing system, and is which a service of providing an input print job to the registered printer is performed, wherein
the first cloud printing system includes a holding unit that holds registration information including information indicating the registered printer and information indicating that the registered printer was registered from the first cloud printing system to the second cloud printing system, and a receiving unit that receives a request, the printer management method comprising:
in a case where the received request is a request to delete the registered printer,
transmitting to the second cloud printing system a request to delete a printer registered in the second cloud printing system from among one or more deletion target printers, based on the registration information, and
deleting, from the registration information, registration information relating to the registered printer.

16. A printer management method by a cloud cooperation system including a first cloud printing system and a second cloud printing system that cooperates with the first cloud printing system, wherein
the first cloud printing system, in which a registered printer can be registered in a second cloud printing system and in which a service of providing an input print job to the registered printer is performed, includes a holding unit that holds registration information for each tenant including information indicating the registered printer and information indicating that the registered printer was registered from the first cloud printing system to the second cloud printing system, and a receiving unit that receives a request, and
the second cloud printing system holds second registration information indicating a second registered printer,
the printer management method comprising:
in a case where the received request is a request to merge a merge source tenant belonging to the first cloud printing system with a merge destination tenant,
merging the registration information relating to the registered printer belonging to the merge source tenant with the merge destination tenant based on the registration information,
transmitting to the second cloud printing system a request to register, from among one or more registered printers merged with the merge destination tenant, a printer for which registration in the second cloud printing system is indicated by the registration information, and
transmitting to the second cloud printing system a request to delete a printer registered in the second cloud printing system from among one or more registered printers belonging to the merge source tenant, based on the registration information;
in a case where a request to register a printer is received from the first cloud printing system, the second cloud printing system registers the printer in the second registration information; and
in a case where a request to delete a printer is received from the first cloud printing system, the second cloud printing system deletes the printer from the second registration information.
